(19) United States
(12) Patent Application Publication
(10) Pub. No.: US 2018/0359105 A1
(43) Pub. Date: Dec. 13, 2018

(54) AUTOMATED MEETING CONNECTION

(71) Applicant: Microsoft Technology Licensing, LLC, Redmond, WA (US)

(72) Inventor: Jacob H. Nieman, Seattle, WA (US)

(21) Appl. No.: 15/616,185

(22) Filed: Jun. 7, 2017

(51) Int. Cl. H04L 12/18; G06Q 10/10; G06Q 10/06; G10L 19/018; H04N 21/8358; G06F 17/30

(52) U.S. Cl. CPC H04L 12/1818; G06Q 10/1095; G06F 17/30882; G10L 19/018; H04N 21/8358; G06Q 10/06314

(57) ABSTRACT

The disclosed technology allows a user of a computing device or a shared device to automatically join an event, meeting, or other collaboration event when the user's computing device is communicatively connected to a shared device. In one implementation, the method includes determining initiation of a communication connection between the computing device and the shared device. In response to such determination, an identity element is embedded in a content being communicated from the computing device to the shared device and the content with the embedded identity element is communicated to the shared device. The identity element may be an identifier of a user of the computing device or a collaboration event identifier for the user. In one implementation, the shared device may use the identity element to join the collaboration event.

### BACKGROUND

When a person is presenting information, connecting to a device, or collaborating on projects in a meeting, a computer device may be used to aid in discovery, and connection, as well as presenting and collaborating with other people.

### SUMMARY

This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

Implementations described herein disclose a system for providing automated meeting connection to computing devices.

The disclosed technology allows a user of a computing device or a shared device to automatically join an event, meeting, or other collaboration event when the user's computing device is communicatively connected to a shared device. In one implementation, the method includes determining initiation of a communication connection between the computing device and the shared device. In response to such determination, an identity element is embedded in content being communicated from the computing device to the shared device and the content with the embedded identity element is communicated to the shared device. The identity element may be an identifier of a user of the computing device or a collaboration event identifier for the user. In one implementation, the shared device may use the identity element to join the collaboration event. This allows the shared device to determine if the user is a participant in a collaboration event that is using the shared device.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTIONS OF THE DRAWINGS

A further understanding of the nature and advantages of the present technology may be realized by reference to the figures, which are described in the remaining portion of the specification.

FIG. 1 illustrates an example implementation of system for providing automated collaboration event connection to users of computing devices connected to a shared device.

FIG. 2 illustrates example operations for automatically connecting a user of a computing device to a collaboration event when the computing device is connected to a shared device.

FIG. 3 illustrates alternate example operations for inviting a user of a computing device to join a collaboration event when the computing device is connected to a shared device.

FIG. 4 illustrates example operations for communicating an identity of a user of a computing device to a shared device, when the computing device is connected to the shared device.

FIG. 5 illustrates an example system that may be useful in implementing the described technology.

### DETAILED DESCRIPTIONS

The following describes various implementations of technology that allows a user of a computing device to automatically join a collaboration event when the computing device is communicatively connected to a shared device that may be used in the collaboration event. Such collaboration event may be a meeting including a group of participants, a presentation to a group of participants, a collaborative game, a collaborative product development event such as software coding, etc.

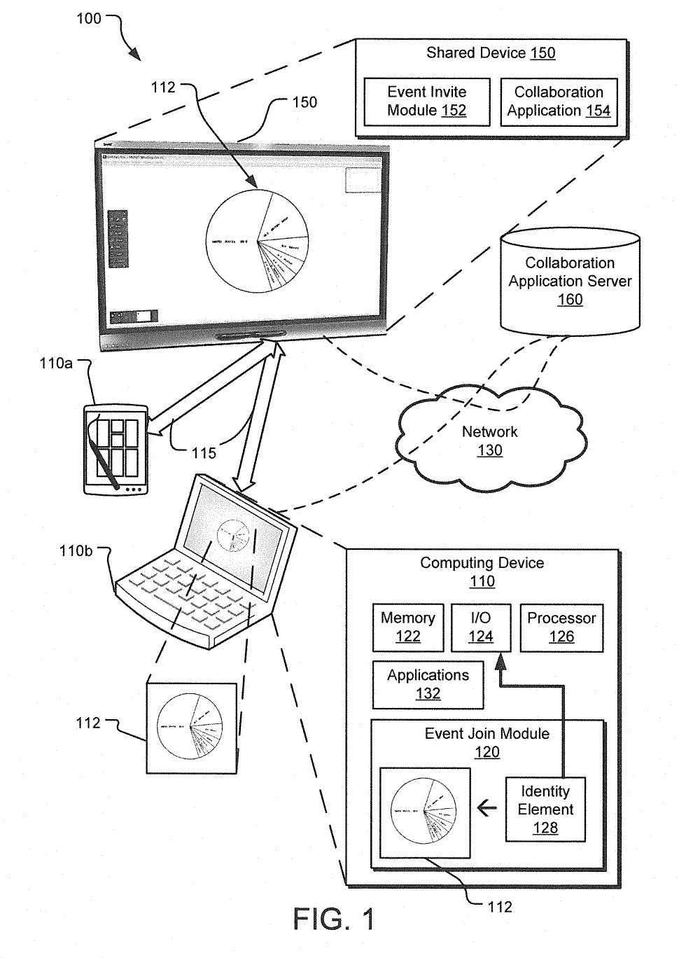

FIG. 1 illustrates an example implementation of a collaboration system 100 for providing automated collaboration event connection to users of computing devices connected to a shared device. Specifically, the collaboration system 100 discloses various computing devices 110 such as a tablet 110a, a laptop 110b (collectively referred to herein as the “computing device 110”) that are communicatively connected to a shared device 150. Alternatively, the computing device 110 may be a desk top computer, a smartphone, a personal digital assistant (PDA), etc.

An example of the shared device 150 may be a multi-touch collaboration device that allows content to be presented by various participants, revise the presented content, and share the content among various participants of the collaboration event. The communication connection 115 between the computing device 110 and the shared device 150 may be a wired connection, such as high definition media input (HDMI) cable, video graphic adapter (VGA) cable, digital visual interface (DVI) cable, DisplayPort cable, universal service bus (USB) cable, etc. Alternatively, the shared device 150 may be configured to connect to various user computing devices 110 wirelessly using WiFi Direct connection, Bluetooth connection or a Bluetooth low energy (BLE) connection, a WiMax connection, WiFi network based connection, a wireless local area network (LAN) connection, etc.

Additionally, the collaboration system 100 also includes a network 130, such as the Internet that is communicatively connected to the computing device 110, the shared device 150, and a collaboration application server 160. The collaboration application server 160 may be a cloud based application server for a collaboration service, such as a teleconferencing service, a web conferencing service, a gaming service, etc. In one implementation, the collaboration application server 160 may store user identifications or login identifications of various users of the collaboration application. For example, the collaboration application server 160 may store such identifications of the users of the computing device 110. Yet alternatively, the collaboration application server 160 may also store device identification information such as computer serial numbers, mobile device international mobile equipment identity (IMEI) numbers, etc., associated with various users of the collaboration applications.

In one implementation, the computing device 110 includes an event join module 120 that automatically connects the user of the computing device 110 to a collaboration event when the communication connection 115 is established between the computing device 110 and the shared device 150. In one implementation, the event join module 120 may be implemented with various computer instructions stored on a memory 122. The computing device 110 may include a processor 126 that may be used to execute the computer instructions implementing the event join module 120.

The computing device 110 also includes an input/output (I/O) module 124 that can be used by the computing device 110 to communicate with other devices. The I/O module 124 may include one or more I/O ports, transmitters, receivers, etc. For example, the I/O module 124 may include an HDMI port that allows the computing device 110 to communicate using an HDMI communication as the communication connection 115 with the shared device 150. Alternatively, the I/O module 124 may include a wireless I/O port including a transceiver for wirelessly communicating with the shared device 150.

In one implementation, the I/O module 124 is configured to detect presence of a communication network or a communication connection that it may be able to use as the communication connection 115 to communicate with the shared device 150 and other devices connected to such network. For example, when the user of the computing device 110 walks into a room that has a WiFi network that the computing device 110 can join, the I/O module 124 detects the presence of the network. In one implementation, the I/O module 124 may automatically join the computing device 110 to such network. Alternatively, the computing device 110 may request the user of the computing device 110 join such network. Once the I/O module 124 has initiated the communication connection 115 between the computing device 110 and the shared device 150, it sends a message to the event join module 120 of the initiation of the communication connection 115.

In one implementation, the event join module 120 generates an identity element 128 that can be used to identify the user of the computing device 110. For example, if the computing device 110 is a laptop, the event join module 120 may generate the identity element 128 based on a serial number of the computing device 110. Alternatively, if the computing device 110 is a smartphone, the event join module 120 may generate the identity element 128 based on an IMEI number of the computing device 110. Yet alternatively, the identity element 128 may be generated based on a user identification stored on the computing device 110 or on the collaboration application server 160. Alternatively, if the user of the computing device 110 has a login identification to a collaboration application, such as a teleconference call application, an online conferencing service, etc., the event join module 120 may generate the identity element 128 based on such user login identification. In other implementations, the event join module 120 may generate the identity element 128 based on links to collaboration events that may be sent to participants of the collaboration events.

Upon receiving the message about the initiation of the communication connection 115, the event join module 120 may determine the type of the communication connection 115 to determine a method to communicate an identity element 128 to the shared device 150 via the communication connection 115. For example, if the communication connection 115 is a WiFi direct connection, the event join module 120 may communicate the identity element 128 via the I/O module 124 during setting up of such WiFi direct connection between the computing device 110 and the shared device 150. Alternatively, if the communication connection 115 is a Bluetooth based connection, the event join module 120 may communicate the identity element 128 via the I/O module 124 as a Bluetooth message to the shared device.

If the communication connection 115 is a wired connection, the event join module 120 may encode the identity element 128 in a video stream being communicated via the I/O module 124. Specifically, the event join module 120 may hide the identity element 128 into the video stream being communicated over the communication connection 115 in such a manner that it does not affect the quality of the video stream and such that if the video stream was being compressed, the value of the identity element 128 is not lost in such compression. Alternatively, the event join module 120 may inform the I/O module 124 to initiate a complementary video message over the communication connection 115 where such complementary video message includes the identity element 128.

In an alternative implementation, the event join module 120 may determine if there is any active collaboration event for which the user of the computing device 110 is a participant. For example, the event join module 120 may store such information based on its communication with other applications 132 on the computing device such as an email application, a scheduling application, a collaboration application, etc. For example, the application 132 may be a client collaboration application that works with the collaboration application server 160.

Upon determining that the user of the computing device 110 is a participant of a collaboration event, the event join module 120 communicates with one or more of the applications 132 to determine any content that the user will be sharing with the shared device 150. For example, the collaboration event may be a meeting where the user of the computing device 110 is presenting a presentation 112 on the shared device 150. In this case, the event join module 110 embeds the identity element 128 into the presentation 112. In one implementation, the event join module 110 may embed the identity element 128 into the presentation 112 at predetermined pixels such that the quality of the presentation is not adversely affected. For example, the identity element 128 is embedded in approximately the last set of pixels of the presentation 112.

If the event join module 120 determines that the user of the computing device 110 is not going to share any content with the shared device 150, the event join module 110 may send a message via the collaboration application to the shared device 150, where such message has the identity element 128 embedded therein. For example, the event join module 110 may embed the identity element into a message communicated via a chat function of the collaboration application.

Alternatively, the identity element 128 information may be modulated over an audio signal (such as voice over IP) shared by the collaboration application between the computing device 110 and the shared device 150. For example, the identity element 128 may be embedded in an audio signal as in the form of an audio watermark. Specifically, such audio watermark may be generated using the identity element 128 such that the audio watermark is not lost during communication of the audio signal from the computing device 110 to the shared device 150 over the communication connection 115. In an alternative implementation, the identity element 128 information may be modulated over a video signal (such as a video stream) shared by the collaboration application between the computing device 110 and the shared device 150. Specifically, one or more frames of the video stream may include a video watermark including the identity element 128. For example, the identity element 128 may be embedded as a video watermark at predetermined pixels of various frames of the video stream communicated from the computing device 110 to the shared device 150.

In other implementations, any signal shared between the computing device 110 and the shared device 150 may be used to communicate the identity element to the shared device. Examples include video signal, audio signal, radio frequency communication signals, infrared communication signals, and acoustic or ultrasonic communication signals.

Upon receiving the identity element 128 at the shared device, an event invite module 152 at the shared device 128 analyzes the content received from the computing device to extract the identity element 128. For example, if the identity element 128 is embedded by the event join module 120 in the presentation 112, the event invite module 152 extracts the identity element 128 from the presentation 112. Similarly, if the identity element 128 is embedded in an audio signal or a video signal, the event invite module 152 extracts the identity element 128 from the audio signal or the video signal received from the computing device. The event invite module 152 further extracts user identity from the identity element 128. Such user identity may be, for example, a serial number of the computing device 110, a collaboration application user identification, or a login identification of the user of the computing device 110 for the collaboration application.

After extracting the identity element 128, the event invite module 152 communicates with a collaboration application 154 on the shared device 150 to determine if the user, as identified by the user identity extracted from the identity element 128, is participant to any collaboration event. For example, the event invite module 152 may send the user identity to the collaboration application 154 with a request to identify any collaboration event for which the user is a participant. The collaboration application 154 may compare the user identity with various collaboration event participants' identifications such as login identifications to determine if the user is a participant in any collaboration event and notifies the event invite module 152 accordingly.

If the collaboration application 154 notifies the event invite module 152 that the user of the mobile computing device 110 is a participant in a collaboration event, the event invite module 152 sends an invite to such a collaboration event to the computing device 110. Alternatively, the event invite module 152 may inform the collaboration application 154 to automatically join the user to the collaboration event and/or send confirmation to the computing device 110.

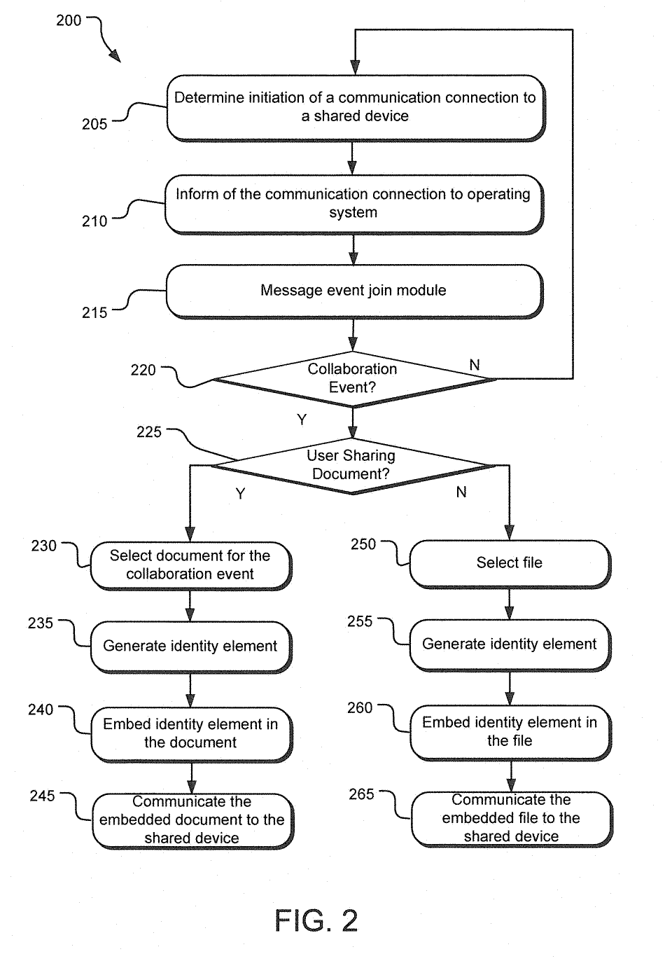

FIG. 2 illustrates example operations 200 for automatically connecting a user of a computing device (such as the computing device 110 of FIG. 1) to a collaboration event when the computing device is connected to a shared device (such as the shared device 150 of FIG. 1). An operation 205 determines initiation of a communication connection between the computing device and a shared device. For example, the operation 205 may be implemented by an I/O controller of the computing device that determines such initiation of a communication connection based on signals at I/O ports of the computing device. For example, the I/O controller may determine initiation of a communication connection to a shared device via a HDMI cable at one of the I/O ports of the computing device at the end of an appropriate handshake as required by the HDMI protocol.

An operation 210 informs the operating system of the computing device of the initiation of the communication connection with the shared device. For example, the operation 210 may be effectuated by the I/O controller sending a message to a processor of the computing device of the initiation of the communication connection. An operation 215 initiates a message to an event join module (such as the event join module 120 of FIG. 1) informing the event join module of the communication connection with a shared device.

A determining operation 220 determines if there is a collaboration event for which the user of the computing device may be a participant. The determining operation 220 may make such a determination based on inquiries to various applications on the computing device. For example, the determining operation 220 may inquire a calendar application, a collaboration application, or an email application. Alternatively, the determination operation 220 may send a message to a collaboration application server (such as the collaboration application server 160 of FIG. 1) with an identity of the user of the computing device to determine if there is such a collaboration event. In response to determining that the user is a participant of a collaboration event, an operation 225 determines if the user is sharing any document with the shared device as part of the collaboration event.

An operation 230 selects a document that may be used in the collaboration event. For example, such a document may be a presentation document that may be communicated as part of the collaboration event between the computing device and the shared device. An operation 235 generates an identity element for the user of the computing device. In one implementation, the operation 235 generates the identity element based on a serial number of the computing device. Alternatively, in one implementation, if the computing device is a smartphone, the operation 235 generates the identity element based on an IMEI number of the computing device. Yet alternatively, the identity element may be generated based on a user identification stored on the computing device or on a collaboration application server.

An operation 240 embeds the identity element into the selected document for the collaboration event. In one implementation, where the selected document is a presentation document, the identity element may be embedded in the presentation document at predetermined pixel location of the presentation. Specifically, the identity element is embedded in the presentation document such that it does not adversely affect the quality of the presentation document and such that the identity element is communicated to the shared device even if the presentation document is compressed. An operation 245 communicates the presentation document with the identity information embedded therein to the shared device.

If the operation 225 determines that the user is not presenting any document as part of the collaboration event, an operation 250 selects an alternative file that may be used to convey the identity element to the shared device. For example, such file may be an audio file that may be modulated with the identity element and communicated to the shared device as part of the collaboration event. Alternatively, such file may be a chat message that is part of the collaboration event. An operation 255 generates an identity element for the user of the computing device and an operation 260 embeds the identity element in the file. An operation 265 communicates the file embedded with the identity information to the shared device.

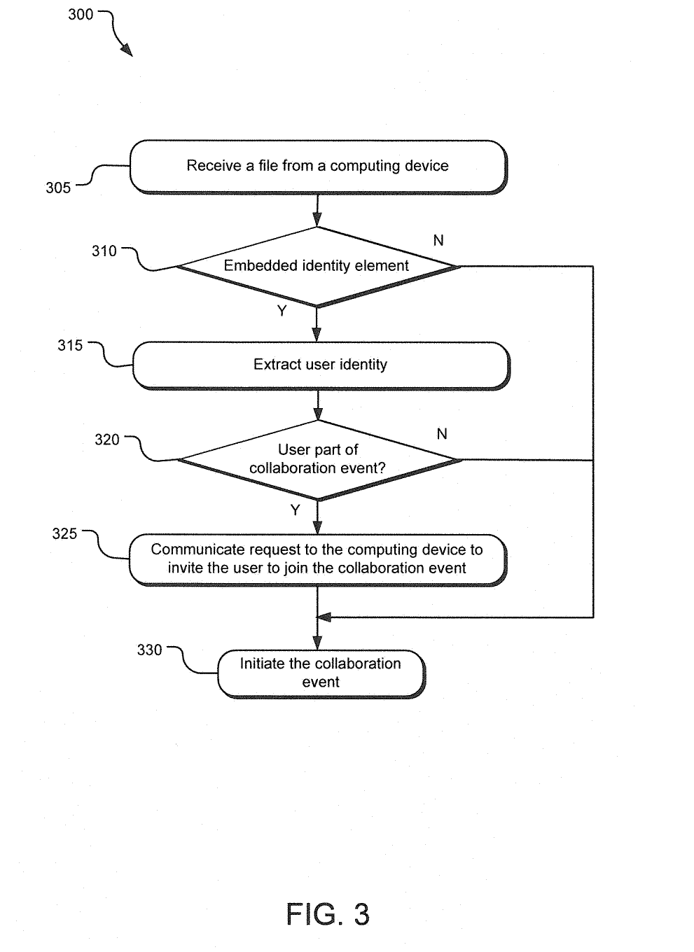

FIG. 3 illustrates alternate example operations 300 for inviting a user of a computing device (such as the computing device 110 of FIG. 1) to join a collaboration event when the computing device is connected to a shared device (such as the shared device 150 of FIG. 1). In one implementation, one or more of the operations may be executed at the shared device. An operation 305 receives a file from the computing device. The received file may be a presentation document shared by the user of the computing device, an audio file, a chat message, etc., communicated by the computing device to the shared device as part of the collaboration event.

An operation 310 determines if there is an identity element or a collaboration event identifier embedded within the file received from the computing device. For example, the operation 310 may make such determination based on a message received from the computing device or a parameter of the received file. In one implementation, when the computing device sends a file to the shared device with embedded identity element or the collaboration event identifier, it may notify the shared device in some manner of its doing so. In response to determining that the file has an identity element or the collaboration event identifier, an operation 315 extracts the identity element or the collaboration event identifier and further extracts the user identity from the identity element or the collaboration event identifier. Such user identity may be an identification of the user for a collaboration application, an email address of the user, a serial number of the computing device of the user, etc.

An operation 320 determines if the user is a participant in a collaboration event using the shared device. In one implementation, the operation 320 makes such determination based on an inquiry to a collaboration application running on the shared device, or based on an inquiry to a collaboration application server. In response to determining that the user is a participant in a collaboration event, such as a meeting, an operation 325 communicates a request to the computing device to invite the user of the computing device to join the collaboration event. In an alternative implementation, the user may be automatically joined to the collaboration event and the operation 325 communicates a message to the computing device of having the user joined to the collaboration event. An operation 330 initiates the collaboration event.

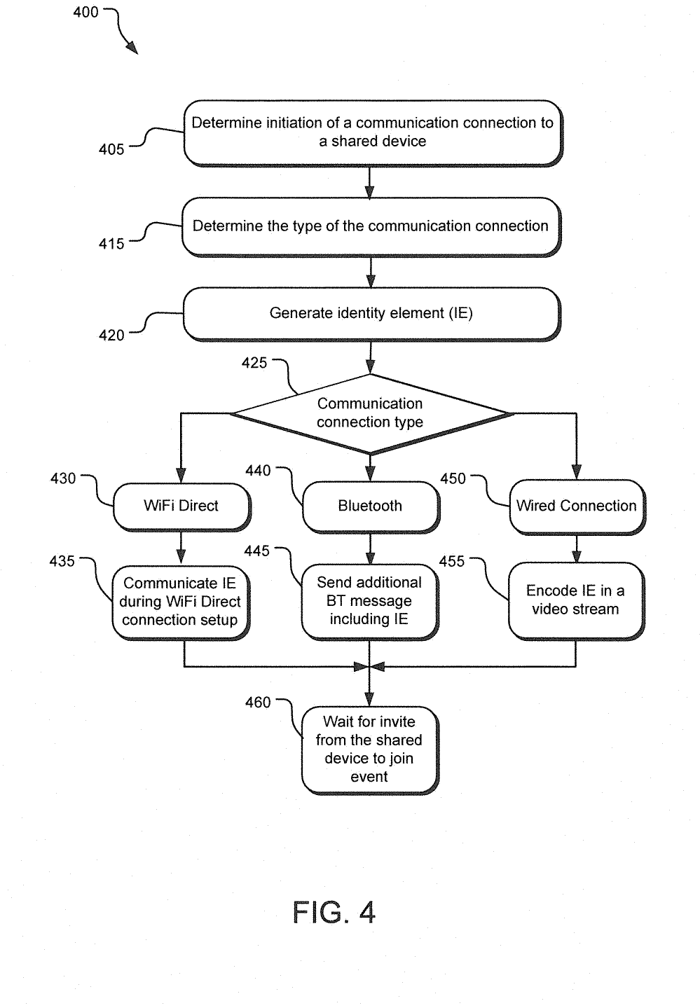

FIG. 4 illustrates example operations 400 for communicating an identity of a user of a computing device to a shared device (such as the computing device 110 of FIG. 1), when the computing device is connected to the shared device (such as the shared device 150 of FIG. 1). An operation 405 determines initiation of a communication connection between the computing device and a shared device. For example, the operation 405 may be implemented by an I/O controller of the computing device that determines such initiation of a communication connection based on signals at I/O ports of the computing device.

An operation 415 determines the type of communication connection between the computing device and the shared device. For example, the operation 415 may make such determination based on the information received from the I/O controller of the computing device. An operation 420 generates an identity element for the user of the computing device. A determining operation 425 evaluates the type of the communication connection. If the communication connection is a WiFi direct connection as per 430, an operation 435 communicates the identity element over the communication connection during the setting up of the WiFi direct connection. If the communication connection is a Bluetooth connection as per 440, an operation 445 sends a Bluetooth message to the shared device with the identity element. On the other hand, if the communication connection is a wired connection as per 450, an operation 455 encodes the identity element in a video stream that is communicated to the shared device over the wired connection. An operation 460 waits for an invite from the shared device to join a collaboration event.

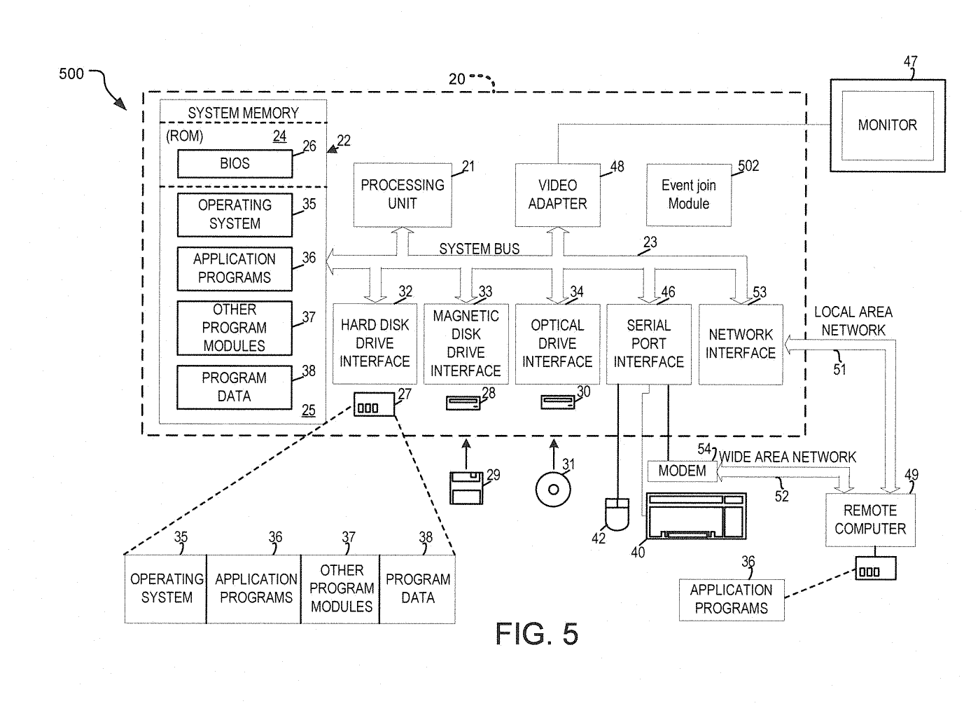

FIG. 5 illustrates an example system 500 that may be useful in implementing the described technology for providing automated event connection to a user of a computing device to a shared device (such as the computing device 110 of FIG. 1), when the computing device is connected to the shared device (such as the shared device 150 of FIG. 1). The example hardware and operating environment of FIG. 5 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 5, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk drive 27, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 6 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are examples and other means of communications devices for establishing a communications link between the computers may be used.

In an example implementation, software or firmware instructions for providing automated event connection may be stored in memory 22 and/or storage devices 29 or 31 and processed by the processing unit 21. Rules for providing automated event connection may be stored in memory 22 and/or storage devices 29 or 31 as persistent datastores. For example, an event join module 502 may be implemented on the personal computer 20 (alternatively, the event join module 502 may be implemented on a server or in a cloud environment). The event join module 502 may utilize one of more of the processing unit 21, the memory 22, the system bus 23, and other components of the personal computer 20.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The system for providing automated event connection may include a variety of tangible computer-readable storage media and intangible computer-readable communication signals. Tangible computer-readable storage can be embodied by any available media that can be accessed by the automated event join module 250 (as disclosed in FIG. 2) and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the automated meeting connection 210 (as disclosed in FIG. 2). In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

The automated meeting connection system disclosed herein provides solution to a technological problem necessitated by the increasing use of computers in collaborative events and technical difficulties in joining participants to collaborative events. Specifically, the automated meeting connection system disclosed herein provides an unconventional technical solution to this technological problem by providing a system and method that allows a user of a computing device to automatically join an event, meeting, or other collaboration event when the user's computing device is communicatively connected to a shared device. In one implementation, the method includes embedding an identity element in a content being communicated from a computing device to a shared device in response to determining an initiation of a communication connection between the computing device and the shared device and communicating the content with the embedded identity element to the shared device, which may allow the shared device to determine if the user is a participant in a collaboration event that is using the shared device.

A method for providing an automated connection to a collaboration event by a computing device includes determining initiation of a communication connection between the computing device and a shared device, in response to determining the initiation of the communication connection, embedding an identity element in content being communicated from the computing device to the shared device, and communicating the content with the embedded identity element to the shared device. In one implementation of the disclosed method, the identity element is at least one of an identifier of a user of the computing device, a collaboration event identifier for the user, and a link to the collaboration event. In an alternative implementation, the method further includes receiving, at the computing device, a request from the shared device to join the collaboration event.

An implementation of the method for providing an automated connection to a collaboration event to a computing device further includes generating the identity element based on a serial number of the computing device and an identification of a user for the collaboration event. In an alternative implementation, the identity element is embedded in a presentation for the collaboration event. In another implementation, the identity element is embedded at predetermined pixels of the presentation. Alternatively, the identity element is embedded in an audio content in form of an audio watermark or in a video content in form of a video watermark.

A method of providing an automated connection to a collaboration event for a computing device includes receiving at a shared device, content from the computing device, the content including an identity element embedded therein, extracting the identity element from the content, determining at least one of an identity of a user and a collaboration event identifier for the user from the identity element and determining that the user is a participant in a collaboration event based on the identity of the user or the collaboration event identifier of the user. In one implementation, the method further includes communicating a request to the computing device to join the collaboration event in response to determination that the user is a participant in a collaboration event.

In another implementation, extracting the identity element from the content further comprises at least one of extracting the identity element from an audio watermark in audio content received from the computing device or extracting the identity element from a video watermark in video content received from the computing device. In yet another implementation, determining the identity of the user from the identity element further comprises determining a serial number of the computing device from the identity element. Alternatively, determining the identity of the user from the identity element further comprises determining a collaboration event identification of the user from the identity element. In one implementation, the method further includes determining if the user is a participant in the collaboration event using the collaboration event identification of the user by communicating the collaboration event identification to a collaboration application server.

A physical article of manufacture including one or more tangible computer-readable storage media disclosed herein encodes computer-executable instructions for executing on a computer system a computer process to provide an automated connection to a collaboration event for a computing device, the computer process including determining initiation of a communication connection between the computing device and a shared device, and in response to determining initiation of the communication connection, embedding an identity element in data being communicated from the computing device to the shared device, and communicating the data with the embedded identity element to the shared device.

In an implementation of the physical article of manufacture, the computer process further comprises generating the identity element based on a serial number of the computing device. In an alternative implementation, the identity element is at least one of an identifier of a user of the computing device and a collaboration event identifier for the user. In another implementation, the computer process further includes receiving, at the computing device, a request from the shared device to join the collaboration event. In yet another implementation, the computer process further comprises generating the identity element based on a link to the collaboration event. In one implementation, the data being communicated from the computing device to the shared device is a presentation and wherein embedding an identity element in the data further comprises embedding the identity element at predetermined pixels of the presentation. In another implementation, the data being communicated from the computing device to the shared device is a media document and embedding an identity element in the data further comprising embedding the identity element as a media watermark in the media document.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A method of providing an automated connection to a collaboration event by a computing device, the method comprising:
determining initiation of a communication connection between the computing device and a shared device;
in response to determining the initiation of the communication connection, embedding an identity element in content being communicated from the computing device to the shared device; and
communicating the content with the embedded identity element to the shared device.

2. The method of claim 1, wherein the identity element is at least one of an identifier of a user of the computing device, a collaboration event identifier for the user, and a link to the collaboration event.

3. The method of claim 1, further comprising receiving, at the computing device, a request from the shared device to join the collaboration event.

4. The method of claim 1, further comprising generating the identity element based on a serial number of the computing device and an identification of a user for the collaboration event.

5. The method of claim 1, wherein the identity element is embedded in a presentation for the collaboration event.

6. The method of claim 5, wherein the identity element is embedded at predetermined pixels of the presentation.

7. The method of claim 1, wherein the identity element is embedded in audio content in an audio watermark or in video content in a video watermark.

8. A method of providing an automated connection to a collaboration event for a computing device, the method comprising:
receiving at a shared device, content from the computing device, the content including an identity element embedded therein;
extracting the identity element from the content;
determining at least one of an identity of a user and a collaboration event identifier for the user from the identity element;
determining that the user is a participant in a collaboration event based on the identity of the user or the collaboration event identifier of the user; and
in response to determination that the user is a participant in a collaboration event, communicating a request to the computing device to join the collaboration event.

9. The method of claim 8, wherein extracting the identity element from the content further comprises at least one of extracting the identity element from an audio watermark in audio content received from the computing device or extracting the identity element from a video watermark in video content received from the computing device.

10. The method of claim 8, wherein determining the identity of the user from the identity element further comprises determining a serial number of the computing device from the identity element.

11. The method of claim 8, wherein determining the identity of the user from the identity element further comprises determining a collaboration event identification of the user from the identity element.

12. The method of claim 11, further comprising determining if the user is a participant in the collaboration event using the collaboration event identification of the user by communicating the collaboration event identification to a collaboration application server.

13. The method of claim 8, wherein the identity element is embedded at predetermined pixel of a presentation for the collaboration event.

14. A physical article of manufacture including one or more tangible computer-readable storage media, encoding computer-executable instructions for executing on a computer system a computer process to provide an automated connection to a collaboration event for a computing device, the computer process comprising:
determining initiation of a communication connection between the computing device and a shared device;
in response to determining initiation of the communication connection, embedding an identity element in data being communicated from the computing device to the shared device; and
communicating the data with the embedded identity element to the shared device.

15. The physical article of manufacture of claim 14, wherein the computer process further comprises generating the identity element based on a serial number of the computing device.

16. The physical article of manufacture of claim 14, wherein the identity element is at least one of an identifier of a user of the computing device and a collaboration event identifier for the user.

17. The physical article of manufacture of claim 14, wherein the computer process further comprises receiving, at the computing device, a request from the shared device to join the collaboration event.

18. The physical article of manufacture of claim 14, wherein the computer process further comprises generating the identity element based on a link to the collaboration event.

19. The physical article of manufacture of claim 14, wherein the data being communicated from the computing device to the shared device is a presentation and wherein embedding an identity element in the data further comprises embedding the identity element at predetermined pixels of the presentation.

20. The physical article of manufacture of claim 14, wherein the data being communicated from the computing device to the shared device is a media document and wherein embedding an identity element in the data further comprises embedding the identity element as a media watermark in the media document.
